(19) United States
(12) Patent Application Publication
(10) Pub. No.: US 2005/0099754 A1
(43) Pub. Date: May 12, 2005

(54) Impedance matched surge protected coupling loop assembly

(75) Inventors: Scott Duncan Hazenboom, Corvallis, OR (US); Eric John Blair, Canadensis, PA (US)

Correspondence Address: SUGHRUE MION, PLLC, 2100 PENNSYLVANIA AVENUE, N.W., SUITE 800, WASHINGTON, DC, 20037, US

(73) Assignee: RAIDO FREQUENCY SYSTEMS, INC.

(21) Appl. No.: 10/704,815

(22) Filed: Nov. 12, 2003

(51) Int. Cl. H02H 9/06

(52) U.S. Cl. 361/118

(57) ABSTRACT

A tower top amplifier for use outdoors in a radio frequency communications system has a surge suppression device for suppressing electrical surges caused by lightning strikes. The surge suppression circuit has a short circuit inductive coupling loop connected to a coaxial cable connector. By using a capacitor connected in parallel with an inductive probe, the surge suppression circuit operates as an open circuit at the operating frequency of the system. In addition, at the operating frequency, the resistor matches the impedance of the system connected to the coaxial cable connector. But in the event of a lightning strike or other electrical event, the inductive coupling loop short circuits the surge current to ground, thereby protecting the amplifier system from damage.

### BACKGROUND OF THE INVENTION

1. Field of the Invention

The present invention relates to surge protection devices for use in radio frequency communications systems. More particularly, the present invention relates to a short circuit inductive coupling loop for use in outdoor tower top amplifiers for protecting sensitive amplifier components from electrical surges and spikes caused by lightning and other outdoor electrical phenomena.

2. Background

Radio frequency communication systems typically have antenna towers for transmitting and receiving radio frequency signals transmitted in the system. These antenna towers have tower top amplifiers for amplifying these signals prior to transmission or after reception. In addition, these tower top amplifiers have non-directional coupled ports for injecting signals into the receive path or sampling signals from the transmit path of the system. Typically, these amplifiers are connected to the receiver and transmitter by coaxial cable, so it is convenient to locate these coupled ports at coaxial cable connectors in the system.

But because these antenna towers are located outdoors, they are often struck by lightning. In order to protect the amplifiers and other electrical devices located on the tower from damage due to electrical surges from lightning strikes, it is necessary to include some surge protection device. Typically, the surge protection is provided by a dual port, inline coaxial surge suppressor, which is connected to the coaxial cable close to the device being protected.

To minimize additional size and weight, dual port surge suppressors are often replaced by single port closed circuit or open circuit probe elements for applications requiring electromagnetic coupling of a signal into or out of the system. While conventional closed circuit probes provide for sufficient surge suppression against high power electrical surges, they have very poor impedance relative to the amplifier system, thereby interfering with and degrading the signal at the operating frequency of the system. Likewise, the impedance of conventional open circuit probes does not adequately match that of the amplifier system to which it is connected for most applications. To obtain proper impedance matching, it has been necessary to include bulky external surge suppressors on the towers. However, because of constraints on size and weight at the tower top, it is undesirable to include external suppressors of this kind.

For example, Japanese Patent No. 7030442 shows a surge suppression device with impedance matching for use in a broadcasting apparatus on an antenna tower. The impedance matching circuit includes an LC network having three inductors, two capacitors, and a multipole arrestor. A first inductor is connected in parallel with the two capacitors and a second inductor. One of the capacitors and the third inductor are connected to ground. The multipole arrestor acts as an impedance across the input connected to ground and the first inductor, and acts as a different impedance across the output connected to ground and in parallel with the third inductor. As is evident from this description, this device requires a number of different precision parts so that the impedances at the input and output are properly matched.

In many applications, it is undesirable to include a surge suppressor of this kind because, due to its complexity, it can substantially increase the size and weight of the tower top amplifier system. What is needed is a single port surge suppressor of relatively simple design and construction, whose small size and reduced weight are suitable for use on a tower top radio frequency amplifier, but which is also capable of matching the impedance of the system without additional parts or excessive size.

### SUMMARY OF THE INVENTION

In an illustrative embodiment, the present invention provides an apparatus for suppressing electrical surges in a high power, non-directional radio frequency amplifier system. The apparatus has a coaxial cable connector having a center contact for connection to a center conductor of a coaxial cable that carries signals in an operating frequency range and having a ground contact for connection to a ground conductor of the coaxial cable. The apparatus also has a conductive spacer connected to the ground contact of said coaxial cable connector and a circuit board having at least one resistor and one capacitor disposed thereon, such that the conductive spacer is located between the coaxial connector and said circuit board.

In an illustrative embodiment, the resistor on the circuit board has a predetermined resistance that matches the impedance of the amplifier system and is connected between the center contact of said coaxial cable connector and the conductive spacer. The capacitor is also connected between the center contact of said coaxial cable connector and the conductive spacer, in parallel to the resistor. In addition, a probe having a predetermined length and diameter is connected between said center contact of said coaxial cable connector and said conductive spacer, forming an inductive loop. The reactance of the inductive loop is equal in magnitude to the reactance of the capacitor.

In a first illustrative embodiment, the operating frequency range of the radio frequency amplifier system is from approximately 400 MHz to 3 GHz, the conductive spacer is made of brass, and the resistance of the resistor is approximately 50 ohms.

In a second illustrative embodiment, the operating frequency range of the radio frequency amplifier system is from about 400 MHz to 3 GHz, the conductive spacer is made of brass, and the resistance of the resistor is approximately 75 ohms.

### BRIEF DESCRIPTION OF THE DRAWINGS

FIG. 1 shows a perspective drawing of an embodiment of the present invention.

FIG. 2 shows a schematic diagram of the equivalent circuit of the present invention.

### DETAILED DESCRIPTION OF THE INVENTION

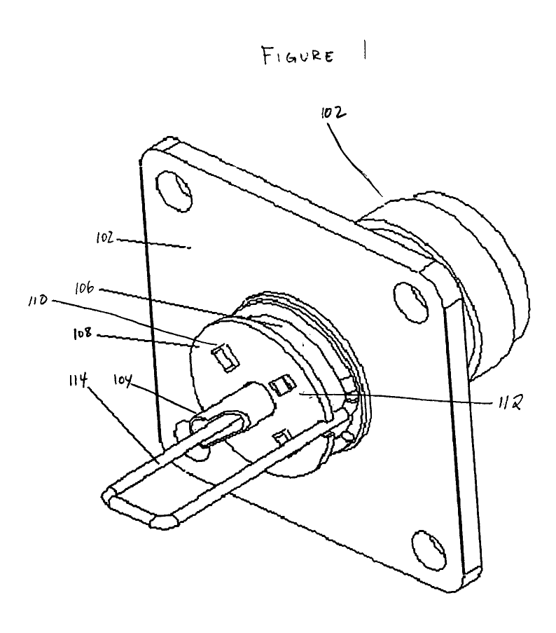

A first illustrative embodiment of a surge suppression device of the present invention connected to a coupled test port is shown in FIG. 1. The surge suppression device has a standard N-type coaxial cable connector 102 with a center contact 104 that extends outward from the connector body, the connector body itself acting also as the ground contact of the coaxial cable which is connected to it. In an illustrative embodiment, the surge suppression device according to the present invention is coupled to a tower top amplifier. The tower top amplifier connects to an antenna on the tower and is used to strengthen signals received by the antenna, thereby preventing deterioration of signal quality and increasing the range of the communication system.

As shown in FIG. 1, the center contact 104 protrudes through a conductive spacer 106, preferably made of brass, and a circuit board 108, both of which have a hole in their surface through which the center contact passes. As shown in FIG. 1, both the brass spacer 106 and the circuit board 108 have a ring shape, with the center contact 104 extending through the hole at the center of the ring.

The conductive spacer 106 sits between the body of the coaxial cable connector 102 and the circuit board 108. Because the conductive spacer 106 makes contact with the body of the coaxial cable connector 102, the conductive spacer 106 is also electrically grounded. In an illustrative embodiment, the circuit board 108 has four resistors 112 built onto it and one capacitor integrated into it, such that the capacitor and the resistors 112 are connected in parallel between the center contact 104 of the coaxial cable connector 102 and ground.

A wire, or probe, 114 is connected at one end to the center contact 104 of the coaxial cable connector 102. At the other end, the probe 114 is connected to the conductive spacer 106. In this configuration, the probe 114 forms an inductive loop and is connected between the center contact 104 of the coaxial cable connector 102 and ground, and is in parallel with both the resistor 112 and the capacitor 110.

The probe 114 is wrapped around the conductive spacer 106 at least once. The dimensions of the probe 114 are selected so as to provide the desired amount of electromagnetic coupling to a resonant cavity within the tower top amplifier system. In an illustrative embodiment, the electromagnetic coupling to a resonant cavity in a filter of the tower top amplifier system is approximately −30 dB. The capacitor is designed with a reactance that will cancel the reactance of the probe 114 at the operating frequency of the system and the resistance of the resistor 112 is chosen to match the impedance of the amplifier system at the operating frequency.

In an illustrative embodiment, the operating frequency of the system is the range 620 to 900 MHz and the resistance is approximately 50 ohms. In another illustrative embodiment, the operating frequency of the system is the range 620 to 900 MHz and the resistance is approximately 75 ohms. However, by changing the loop size and/or the capacitor size, the present invention can be applied to frequencies ranging from about 400 MHz to about 3 GHz.

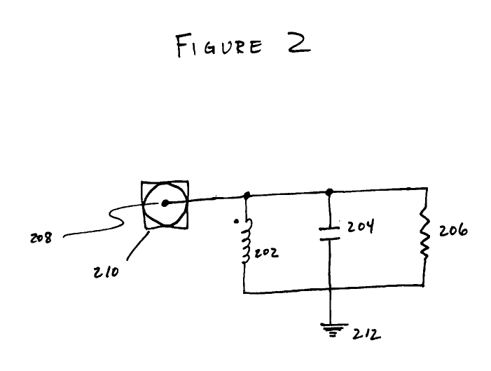

The operation of the surge suppression device according to the present invention will be shown in relation to the equivalent circuit shown in FIG. 2. The inductor 202 formed by the probe, the capacitor 204 and the resistor 206 are all connected in parallel between the center contact 208 of the coaxial cable connector 210 and ground 212. The inductor 202 and the capacitor 204 are chosen so that at the operating frequency of the system, the positive reactance of the inductor and the negative reactance capacitor cancel each other out, forming an open circuit. But because the resistance 206 matches the impedance of the system, the signal carried on the center conductor 208 of the coaxial cable is passed through the surge suppression device and coupled into the resonant cavity substantially unaltered. In the event of a lighting strike or other electrical surge, however, the surge current is shunted to ground through the inductor 202, and is not passed through to any other components of the system.

While the invention has been disclosed in this patent application by reference to the details of exemplary embodiments of the invention, it is to be understood that the disclosure is intended in an illustrative, rather than a limiting sense, as it is contemplated that modifications will readily occur to those skilled in the art, within the spirit of the invention and the scope of the appended claims and their equivalents. For example, it is understood that the invention contemplates reversing the arrangement of the circuit board and the conductive spacer. Further, it is understood that the invention can be utilized in any type of radio frequency communication system which utilizes antenna towers for transmitting and receiving radio frequency signals.

1. An apparatus for suppressing surges in an amplifier system comprising:
a coaxial cable connector having a center contact for connection to a center conductor of a coaxial cable and a ground contact for connection to a ground conductor of the coaxial cable, said coaxial cable carrying signals in an operating frequency range;
a conductive spacer connected to the ground contact of said coaxial cable connector;
a circuit board having at least one resistor and one capacitor disposed thereon, said conductive spacer being disposed between the coaxial cable connector and the circuit board, and said resistor having a predetermined resistance; and
a probe having a predetermined length and width connected at one end to said center contact of said coaxial cable connector and at another end to said conductive spacer, forming an inductive coupling loop,
wherein said resistor is electrically connected between the center contact of said coaxial cable connector and the conductive spacer;
said capacitor connected between the center contact of said coaxial cable connector and the conductive spacer and in parallel to said resistor;
the reactance of the inductive loop is equal in magnitude to the reactance of the capacitor; and
the equivalent parallel resistance of the resistors matches the impedance of the amplifier system.

2. The apparatus of claim 1, wherein the circuit board and the spacer have a ring shape with an open center, and wherein a portion of the center contact of the coaxial cable connector extends through the open center of the circuit board and the spacer.

3. The apparatus of claim 2, wherein the probe is connected to the spacer by being wrapped around the perimeter of the spacer, and wherein the probe is connected to the center contact of the coaxial cable connector by being connected to the portion of the center contact that protrudes through the center of the circuit board and the spacer.

4. The apparatus of claim 1, wherein the operating frequency range is from about 400 MHz to about 3 GHz.

5. The apparatus of claim 1, wherein the operating frequency range is from about 620 MHz to about 900 MHz.

6. A short circuit inductive coupling loop in an amplifier system comprising:
a coaxial cable having a center conductor and a ground;
a coupling inductor;
a capacitor; and
a resistor, wherein said inductor, capacitor, and resistor are connected in parallel between ground and the center conductor of said coaxial cable;
said capacitor and inductor form an open circuit at the operating frequency range of the amplifier system; and
said resistor has a resistance substantially equal to the impedance of the system at the operating frequency range.

7. The coupling loop of claim 6, wherein the operating frequency range is from about 400 MHz to about 3 GHz.

8. The coupling loop of claim 6, wherein the operating frequency range is from about 620 MHz to about 900 MHz.

9. The coupling loop of claim 6, wherein an electromagnetic coupling to a resonant cavity in a filter of the amplifier system is −30 dB.

10. A radio frequency communication system comprising:
an amplifier; and
a surge suppressor coupled to the amplifier, wherein the surge suppressor comprises:
a coaxial cable connector having a center contact for connection to a center conductor of a coaxial cable and a ground contact for connection to a ground conductor of the coaxial cable, said coaxial cable carrying signals in an operating frequency range;
a conductive spacer connected to the ground contact of said coaxial cable connector;
a circuit board having at least one resistor and one capacitor disposed thereon, said conductive spacer being disposed between the coaxial cable connector and the circuit board, and said resistor having a predetermined resistance; and
a probe having a predetermined length and width connected at one end to said center contact of said coaxial cable connector and at another end to said conductive spacer, forming an inductive coupling loop,
wherein said resistor is electrically connected between the center contact of said coaxial cable connector and the conductive spacer;
said capacitor connected between the center contact of said coaxial cable connector and the conductive spacer and in parallel to said resistor;
the reactance of the inductive loop is equal in magnitude to the reactance of the capacitor; and
the equivalent parallel resistance of the resistors matches the impedance of the amplifier system.

11. The system of claim 10, wherein the circuit board and the spacer have a ring shape with an open center, and wherein a portion of the center contact of the coaxial cable connector extends through the open center of the circuit board and the spacer.

12. The system of claim 11, wherein the probe is connected to the spacer by being wrapped around the perimeter of the spacer, and wherein the probe is connected to the center contact of the coaxial cable connector by being connected to the portion of the center contact that protrudes through the center of the circuit board and the spacer.

13. The system of claim 10, wherein the operating frequency range is from about 400 MHz to about 3 GHz.

14. The system of claim 10, wherein the operating frequency range is from about 620 MHz to about 900 MHz.

15. The system of claim 10, further comprising an antenna coupled to the amplifier.

16. A radio frequency communication system comprising:
an amplifier; and
a surge suppressor coupled to the amplifier, wherein the surge suppressor comprises:
a coaxial cable having a center conductor and a ground;
a coupling inductor;
a capacitor; and
a resistor, wherein said inductor, capacitor, and resistor are connected in parallel between ground and the center conductor of said coaxial cable;
said capacitor and inductor form an open circuit at the operating frequency range of the amplifier system; and
said resistor has a resistance substantially equal to the impedance of the system at the operating frequency range.

17. The system of claim 16, wherein the operating frequency range is from about 400 MHz to about 3 GHz.

18. The system of claim 16, wherein the operating frequency range is from about 620 MHz to about 900 MHz.

19. The system of claim 16, wherein the electromagnetic coupling to a resonant cavity in a filter of the amplifier system is −30 dB.

20. The system of claim 16, further comprising an antenna coupled to the amplifier.
